(19) United States
(12) Patent Application Publication
(10) Pub. No.: US 2007/0267155 A1
(43) Pub. Date: Nov. 22, 2007

(54) DOOR FOR AN ENCLOSURE

(76) Inventors: Rich Howe, Pleasant View, UT (US); Kent Ashby, Logan, UT (US); Neil Watson, Layton, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/750,162

(22) Filed: May 17, 2007

Related U.S. Application Data
(63) Continuation-in-part of application No. 29/259,983, filed on May 17, 2006, now Pat. No. D546970.
(60) Provisional application No. 60/801,351, filed on May 17, 2006.

(51) Int. Cl. E06B 3/20

(52) U.S. Cl. 160/232

(57) ABSTRACT

An enclosure may include a relatively large opening that may be large enough to allow cars, trailers and the like to enter the enclosure. The enclosure may include one or more folding doors and/or other types of doors. The enclosure may include one or more blow-molded structures, such as a door panel, a wall panel, a roof panel, a floor panel, other panels and/or other blow-molded structures. The blow-molded structures may include receiving portions that may be sized and configured to receive at least a portion of a reinforcing member. The receiving portions may be integrally formed in an exterior surface of the blow-molded structure during a blow-molding process.

### CROSS-REFERENCE TO RELATED APPLICATIONS

This application claims priority to and the benefit of U.S. provisional patent application Ser. No. 60/801,351, which was filed on May 17, 2006 and entitled SHED.

This application is continuation-in-part of U.S. design patent application Ser. No. 29/259,983, which was filed on May 17, 2006 and entitled DOOR FOR A SHED.

These applications are incorporated by reference in their entireties.

### BACKGROUND OF THE INVENTION

1. Field of the Invention

The invention generally relates to enclosures and, in particular, to sheds.

2. Description of Related Art

Many types of enclosures are used for storing various items such as tools, machines, lawn care equipment, recreational equipment, athletic equipment, supplies and the like. A well known type of storage enclosure is a shed. Conventional sheds are typically relatively small structures that may be either freestanding or attached to another structure, and sheds are often used for storage and/or shelter.

Conventional sheds are often constructed from wood. Wooden sheds, however, are typically very heavy and may require a large amount of time to construct and assemble. Wooden sheds are also frequently constructed from a large number of parts that are connected by screws or bolts. The many parts typically increase the costs of the shed and the amount of time required to assemble the shed. In addition, wooden sheds typically deteriorate over time and often require continual maintenance. For example, conventional wooden sheds may be damaged by rotting or otherwise deteriorating when exposed to the elements. In order to help protect the wood from being damaged, conventional sheds must be periodically painted, stained or otherwise finished. Undesirably, this may result in significant maintenance costs.

Known sheds may also be constructed from metal. For example, the roof and walls of conventional metal sheds may be constructed from sheet metal. Disadvantageously, the sheet metal is often relatively flimsy and easily damaged. In particular, the thin sheet metal walls may be damaged by forces being applied to either the inner or outer walls of the shed. This may cause the walls to undesirably bow inwardly or outwardly and, in some circumstances, may create an opening in the wall. Significantly, the damaged sheet metal may be more susceptible to rust or corrosion and the damaged sheet metal may be very difficult to repair or replace. In addition, conventional metal sheds often have a tendency to rust and deteriorate over time, especially when exposed to the elements. Thus, conventional metal sheds may have to be painted or otherwise protected from rusting or oxidation.

### BRIEF SUMMARY OF EMBODIMENTS OF THE INVENTION

A need therefore exists for an enclosure that eliminates or diminishes the disadvantages and problems described above.

One aspect is an enclosure, such as a shed, that may include an entrance or opening that is large enough to allow cars, trailers and the like to enter. For example, the shed may include an opening that is 110 inches wide. The opening could also be larger or smaller depending, for example, upon the size, shape and/or number of items intended to be placed inside the shed.

Another aspect is a shed that may include an entrance that may be opened or closed. For example, the shed may include doors that may be selectively opened or closed and the doors may be secured in the opened and/or closed positions. The doors may open vertically, horizontally or a combination of vertically and horizontally. In addition, the doors may pivot, slide, roll-up, be removable or the like. Further, the doors may open inwardly and/or outwardly, as desired. Significantly, the doors may be used to create a weather-tight shed but the doors could also include openings, vents, windows and the like, if desired.

Yet another aspect is a shed that may include doors that are constructed from plastic and, in particular, from blow-molded plastic. Advantageously, the blow-molded plastic doors may be relatively rigid, strong, lightweight and easy to manufacture. The doors could also be constructed from other suitable materials and processes, if desired.

Still yet another aspect is a shed that may include doors that create a large entrance to the shed. Preferably the doors have an attractive and aesthetically pleasing appearance. For example, the doors could match other portions of the shed or the doors may contrast with other portions of the shed. In addition, the doors may have a particular style or appearance, such as carriage type door. The doors, however, could have other suitable looks, designs, styles and/or arrangements.

A further aspect is a shed that may include bi-fold doors. In particular, the shed may be at least substantially constructed from blow-molded plastic panels and the bi-fold doors may also be at least substantially constructed from blow-molded plastic panels. The bi-fold doors may extend along the side, end, width or length of the shed, if desired. Advantageously, the bi-fold doors may create a relatively wide entrance to the shed which may allow objects, such as cars or trailers, to be disposed within the shed. The bi-fold doors may also allow large objects to be quickly and easily inserted and/or removed from the shed. Other types of doors, such as tri-fold doors, accordion-type doors and the like, could also be used in connection with the shed. In addition, the doors could have other shapes, sizes, configurations and arrangements depending, for example, upon the intended use of the shed.

Another aspect is a shed that may include a combination of different types of doors. In particular, the shed may include a combination of different types of doors that work together or in concert in connection with an opening. For example, the shed may include an opening with a bi-fold door and a regular door that work in combination to provide a large entrance. Advantageously, this combination of different types of doors may allow a large opening to the shed to be created. It will be appreciated that any suitable combination of doors could be used.

Yet another aspect is an apparatus, such as a shed, that is constructed from blow-molded plastic panels. For example, the shed may include blow-molded plastic panels that form door panels, wall panels, roof panels, floor panels and the like. While these panels and structures are preferably constructed from blow-molded plastic, they may also be constructed from other materials and processes.

Still yet another aspect is an apparatus, such as a shed, that is at least partially constructed from blow-molded plastic structures and reinforcing members. In addition, the blow-molded plastic structures may include receiving portions that are sized and configured to receive at least a portion of the reinforcing members. In particular, the shed may be at least partially constructed from blow-molded plastic structures and the structures may include one or more reinforcing members and/or receiving portions. Advantageously, the receiving portions may be integrally formed during a blow-molding process. In addition, the reinforcing members may have different characteristics and be constructed from different materials than the blow-molded plastic structures, which may allow strong and rigid structures to be constructed. While the reinforcing members are preferably constructed from relatively strong and durable materials such as metal or steel, other suitable materials may also be used.

These and other aspects, features and advantages of the present invention will become more fully apparent from the following detailed description of preferred embodiments and appended claims.

### BRIEF DESCRIPTION OF THE DRAWINGS

The appended drawings contain figures of preferred embodiments to further illustrate and clarify the above and other aspects, advantages and features of the present invention. It will be appreciated that these drawings depict only preferred embodiments of the invention and are not intended to limit its scope. The invention will be described and explained with additional specificity and detail through the use of the accompanying drawings in which:

FIG. 1 is a perspective view of an exemplary shed, illustrating the doors in a closed position;

FIG. 2 is a front view of the shed shown in FIG. 1;

FIG. 3 is a perspective view of the shed shown in FIG. 1, illustrating the doors in a partially opened position;

FIG. 4 is another perspective view of the shed shown in FIG. 1, illustrating the doors in an opened position;

FIG. 5 is a rear perspective view of a portion of the shed shown in FIG. 1;

FIG. 6 is an enlarged view of a portion of the shed shown in FIG. 5, illustrating a connection of a door to the shed;

FIG. 7 is an enlarged view of an exemplary connection of a door to a shed;

FIG. 8 is an enlarged perspective view of another exemplary connection of a door to a shed;

FIG. 9 is an enlarged rear perspective view of a portion of the shed shown in FIG. 1, illustrating a door panel and reinforcing members;

FIG. 10 is an enlarged perspective view of the door panel and a reinforcing member shown in FIG. 9; and

FIG. 11 is an exploded view of the door panel and reinforcing member shown in FIG. 10.

### DETAILED DESCRIPTION OF THE PREFERRED EMBODIMENTS

Before describing preferred and exemplary embodiments in greater detail, several introductory comments regarding the general applicability and scope of the invention may be helpful.

First, the following detailed description of preferred and exemplary embodiments is generally directed towards an enclosure, such as a storage enclosure. It will be appreciated that the storage enclosure may be used to temporarily and/or permanently store a variety of items, objects, devices and the like. The principles of the present invention, however, are not limited to storage enclosures. It will be understood that, in light of the present disclosure, the enclosures disclosed herein can have a variety of suitable shapes, sizes, configurations, arrangements and the like; and the enclosures can be used for a variety of functions, purposes, uses and the like.

Second, the enclosures discussed in more detail below and shown in the accompanying figures are illustrated in connection with exemplary and preferred embodiments of a shed. It will be appreciated that the shed can have a wide variety of suitable arrangements and configurations. It will also be appreciated that the enclosure does not have to be a shed and the enclosures can be other types of structures, such as storage devices, units, boxes, bins, containers, organizers and the like. In addition, the size and dimensions of the shed and its various components can be varied depending, for example, upon the intended use and/or desired purpose of the shed.

Third, the particular materials used to construct preferred and exemplary embodiments of the shed are illustrative. For example, as discussed in greater detail below, blow-molded plastic is preferably used to construct various portions of the shed, such as floor panels, wall panels, door panels and/or roof panels. It will be understood, however, that other materials can be used such as thermoplastics, resins, polymers, acrylonitrile butadiene styrene (ABS), polyurethane, nylon, composites and the like. It will also be understood that other suitable processes may be used, such as extrusion molding, injection molding, vacuum molding, rotational molding and the like. Further, it will be understood that these and other components of the shed can be made from other materials such as metal (including steel, aluminum, etc.), wood and the like.

Further, to assist in the description of the shed, words such as upper, lower, top, bottom, front, back, right and left may be used to describe the accompanying figures. It will be appreciated, however, that the shed can be located in a variety of desired positions, angles and orientations. A detailed description of the shed now follows.

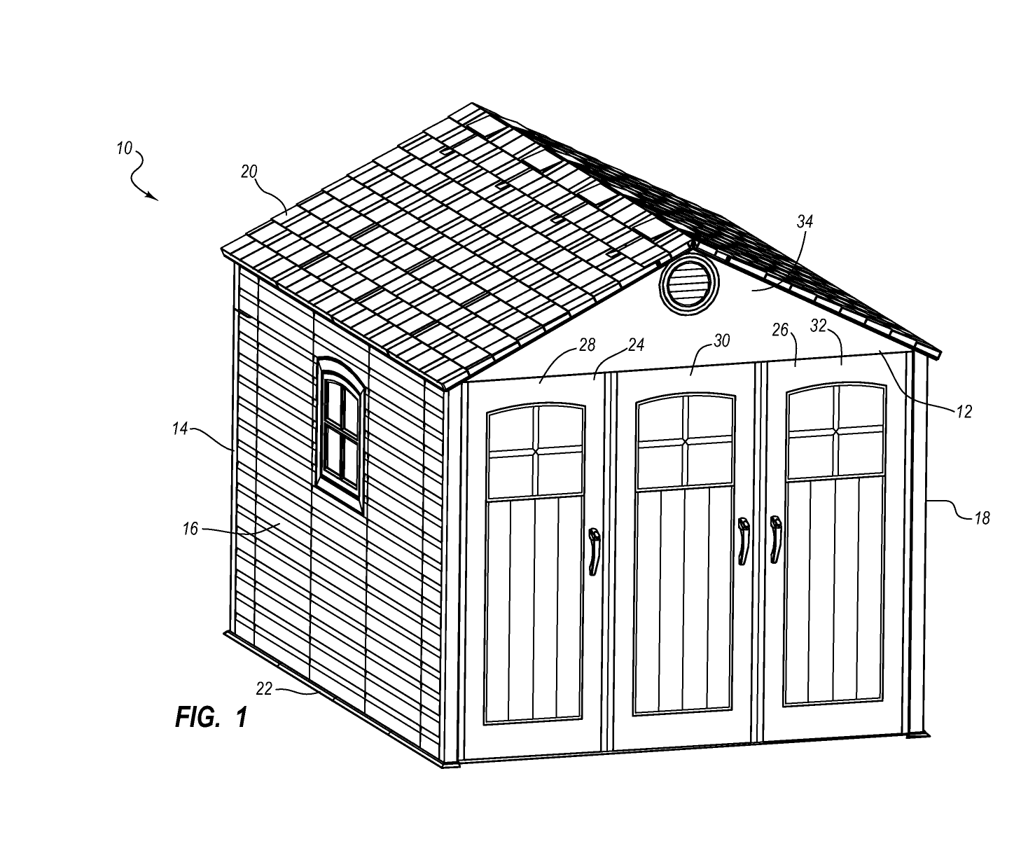

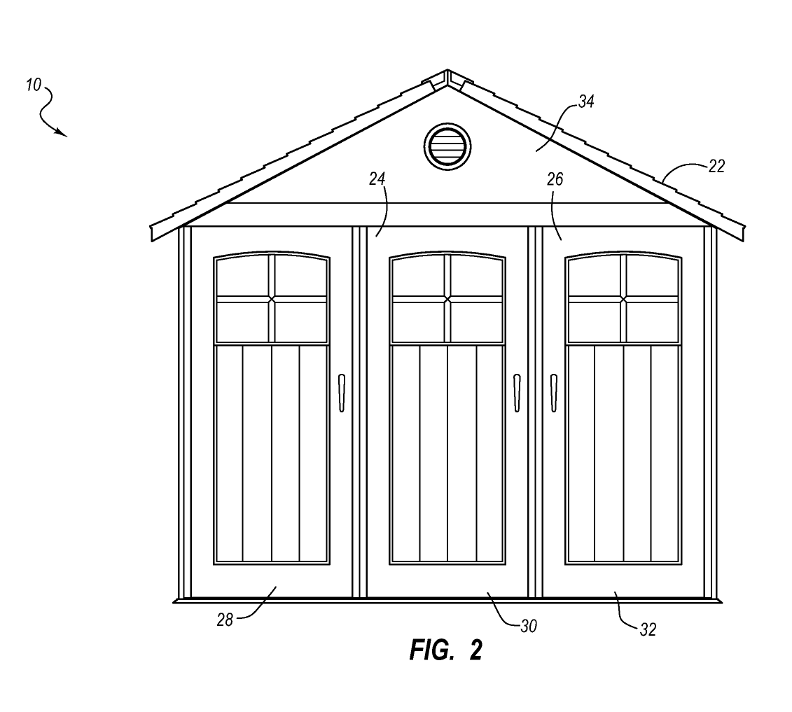

As shown in FIGS. 1 and 2, an exemplary shed 10 may include a front wall 12, a rear wall 14, a left sidewall 16 and a right sidewall 18. The shed 10 may also include a roof 20, a floor 22 and doors 24, 26. While the shed 10 and its components may be shown in the accompanying drawings as having a general size and configuration, it will be appreciated that the shed and its components may be larger, smaller or have other suitable shapes, sizes, configurations and arrangements.

The walls 12, 14, 16, 18; the roof 20; the floor 22 and/or the doors 24, 26 are preferably constructed from lightweight materials such as plastic. For example, these and/or other components of the shed 10 may be constructed from blow-molded plastic. Advantageously, the blow-molded plastic components may be strong, lightweight, rigid and sturdy. In addition, the blow-molded plastic components may be quickly and easily manufactured. The blow-molded plastic components may include hollow interior portions that are formed during the blow-molding process, which may allow lightweight components to be manufactured. Advantageously, this may allow the shed 10 to have significantly lighter weight than conventional sheds constructed from wood or metal. In addition, constructing the shed 10 from blow-molded plastic may allow the shed to be constructed from less plastic, which may save manufacturing costs and reduce consumer costs. The blow-molded plastic may also include ultraviolet (UV) inhibitors that help prevent the plastic from deteriorating when exposed to sunlight.

The shed 10 may also be constructed from blow-molded plastic because this may allow the shed to be economically manufactured. In addition, the blow-molded plastic may allow the shed 10 to be readily produced because, among other reasons, the blow-molded plastic components may be quickly manufactured and may be created with a variety of suitable shapes, sizes, designs and/or colors depending, for example, upon the intended use of the shed. Further, the blow-molded plastic components may be durable, weather resistant, generally temperature insensitive, corrosion resistant, rust resistant and generally do not deteriorate over time. Thus, the blow-molded plastic may allow a long-lasting and durable shed 10 to be constructed.

The blow-molded plastic components of the shed 10 may also include one or more depressions, indentations or the like, and these depressions may be sized and configured to increase the strength and/or rigidity of the components. These depressions, which may also be known as “tack-offs,” preferably cover at least a substantial portion of the components and the depressions may be arranged into a predetermined pattern. The depressions, for example, may be formed in one surface and extend towards an opposing surface. The ends of the depressions may contact or engage the opposing surface and/or the ends of the depressions may be spaced apart from the opposing surface. Advantageously, the depressions may help support the opposing surface and/or increase the structural integrity of the component. In addition, the depressions may be closely spaced in order to increase the strength and/or structural integrity of the component. Further, the depressions may be spaced or positioned into a generally regular or constant pattern so that the component has generally consistent properties. It will be appreciated that the depressions may have a variety of suitable configurations and arrangements. For instance, additional information regarding other suitable configurations and arrangements of the depressions is disclosed in Assignee's U.S. Pat. No. 7,069,865, entitled HIGH STRENGTH, LIGHT WEIGHT BLOW-MOLDED PLASTIC STRUCTURES, which is incorporated by reference in its entirety.

It will be appreciated that the depressions are not required. It will also be appreciated that the components do not have to be constructed from blow-molded plastic and other suitable plastics, materials and/or processes can be used to construct various components depending, for example, upon the intended use of the shed 10. Thus, some or all of the components could also be constructed from other materials with suitable characteristics, such as wood, metal and other types of plastic. Additionally, some or all of the components could be constructed from injection molded plastic, extrusion molded plastic and the like.

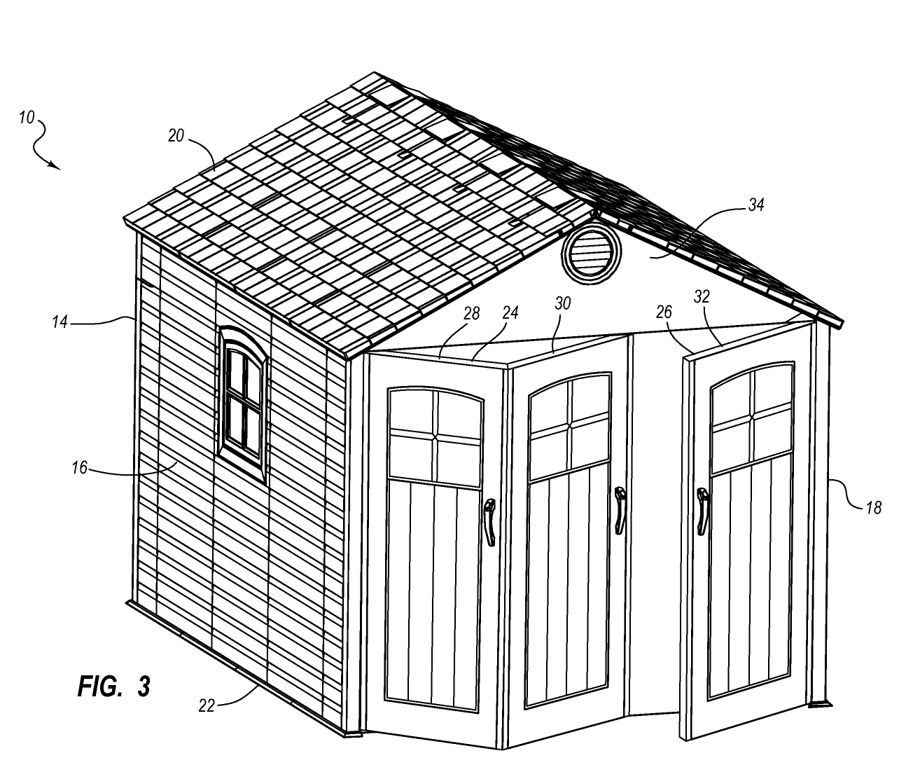

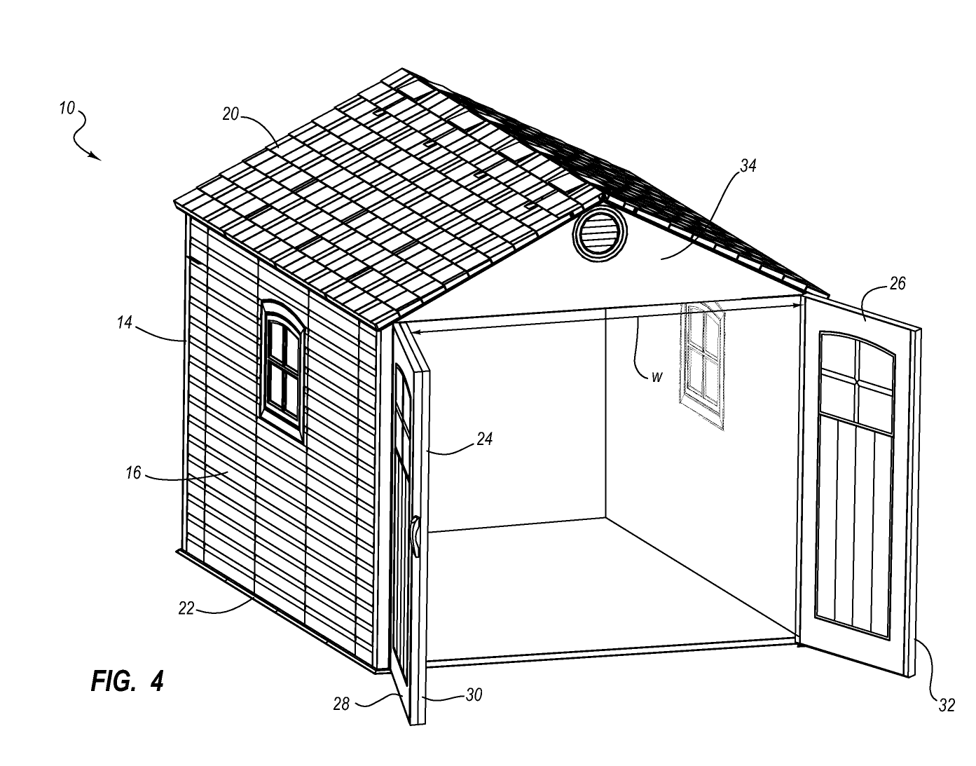

As shown in FIGS. 2-4, the doors 24, 26 may be opened to provide an entrance or opening that is large enough to allow cars, trailers and the like to enter the shed 10. In addition, the doors 24, 26 may extend along all or at least a portion of a wall, side, end, width or length of the shed 10. For example, as best seen in FIG. 4, the shed 10 may include an opening with a width w that is between about 105 inches and about 110 inches (267 centimeters to 279 centimeters) and the doors 24, 26 may be opened or closed as desired to provide access to the interior of the shed 10. Preferably, the opening has a width w of about 108 centimeters (274 centimeters) The opening could also be smaller, such as a width w that is about 95 inches (241 centimeters), about 100 inches (254 centimeters), about 105 inches (267 centimeters) or less. On the other hand, the opening could be larger, such as about 115 inches (292 centimeters), about 120 inches (305 centimeters) or more. Of course, the opening could be larger or smaller depending, for example, upon the size of the item to be placed within the shed 10 and/or the size of the shed. In addition, while the doors 24, 26 preferably completely close the opening when the doors are closed, the doors may only close a portion of the opening.

The shed 10 preferably includes different types of doors in connection with an opening. For example, the shed 10 may include a bi-fold door 24 and a regular door 26 in connection with the same opening or entrance to the shed. Advantageously, the different types of doors 24, 26 may allow the shed 10 to include a large opening. In addition, by using a combination of different types of doors, the doors may be easy to open, close and/or manipulate. It will be appreciated that the shed 10 may include any suitable number and type of doors. For example, the shed 10 may include one or more foldable doors (such as, bi-fold doors, tri-fold doors, accordion-type doors and the like) and/or one or more regular doors.

As shown in FIGS. 1-4, the bi-fold door 24 may include panels 28, 30 and the regular door 26 may include a panel 32. Advantageously, the combination of the bi-fold door 24 and the regular door 26 may create the appearance of three regular doors with a generally consistent size and shape. This may also allow the doors 24, 26 to be easily opened and closed because the panels 28, 30, 32 may have generally the same size and shape. It will be appreciated that the shed 10 may include any suitable combination of doors 24, 26 and panels 28, 30, 32 depending, for example, upon the intended use of the shed 10.

To help provide the large entrance or opening, the panels 28, 30 of the door 24 may move between an unfolded or closed position in which the panels are generally aligned in the same plane as shown in FIGS. 1-2, and a folded or opened position as shown in FIG. 4. In addition, the door 26 may move between a closed position in which the panels 28, 30, 32 are aligned in generally the same plane as shown in FIGS. 1-2, and an opened position as shown in FIG. 4.

The front surfaces of the panels 28, 30 may face generally away from each other when in the folded or opened position (for example, as shown in FIG. 4) and may be generally aligned when in the unfolded or closed position (for example, as shown in FIGS. 1-2). The rear surfaces of the panels 28, 30 may similarly face generally towards each other when in the folded or opened position and may be generally aligned when in the unfolded or closed position.

To facilitate their movement, the doors 24, 26 and/or the panels 28, 30, 32 may be connected to each other and/or other portions of the shed 10. For instance, the panel 32 of the door 26 may connected to the floor 22 and a gable 34, which may allow the door to swing between the open and closed positions. Also, the panel 28 of the door 24 may be connected to the floor 22 and the gable 34. The panel 30 of the door 24 may be connected to the panel 28 to form a bi-fold door. For example, the panel 30 may be movably connected to the panel 28 to form the bi-fold door. In addition, the panel 30 of the door 24 may be connected to the floor 22 and the gable 34. The panel 30, however, does not have to be connected to either the floor 22 or the gable 34. While the doors 24, 26 and/or the panels 28, 30, 32 are preferably connected to the floor 22 and the gable 34, these components may only be connected to the floor or the gable, as desired. In addition, the doors 24, 26 and/or the panels 28, 30, 32 may be connected to other portions of the shed 10, such as the sidewalls or end walls, if desired.

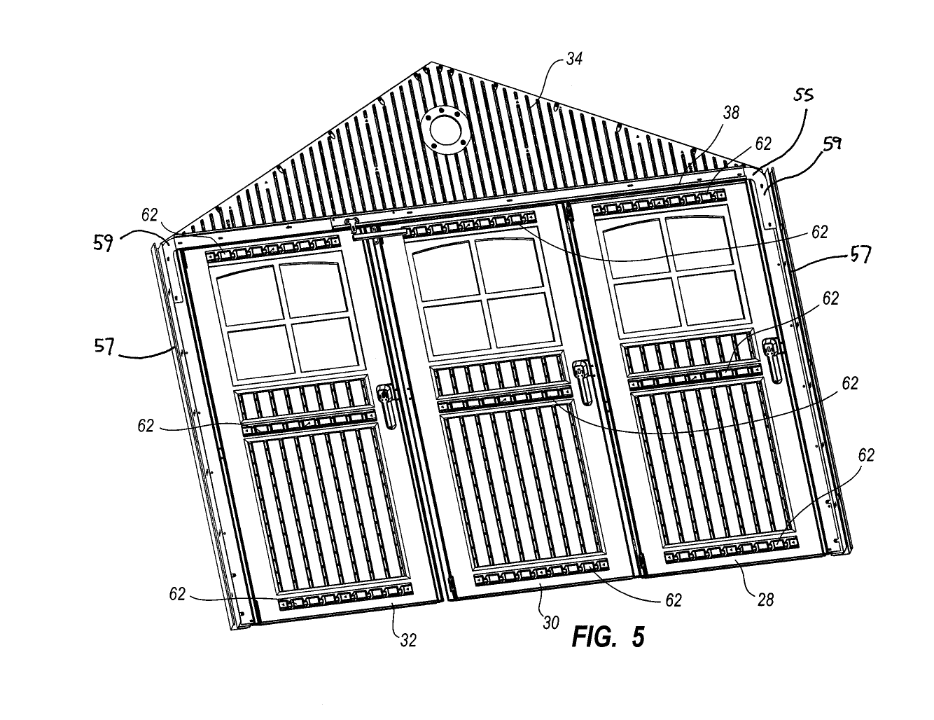

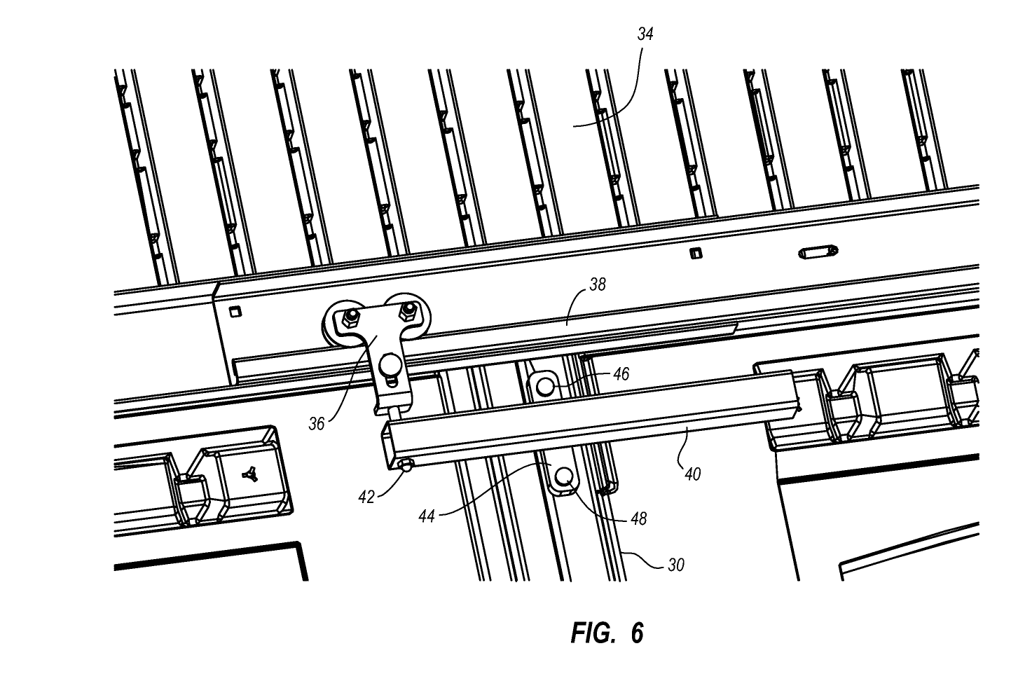

The doors 24, 26 and the respective panels 28, 30, 32 may be connected to each other and/or other portions of the shed 10 using one or more connectors, hinges, tracks, carriages, frames, braces, posts and the like. For instance, in the exemplary embodiment shown in FIGS. 5-6, a roller carriage 36 may be coupled to a track 38, which is preferably connected to the gable 34. The panel 30 of the door 24 may be connected to the carriage 36. In particular, the panel 30 may be connected to a connecting member 40 that is connected to the roller carriage 36 by a fastener 42. As shown in the accompanying figures, the panel 30 may be connected to the connecting member 40 by a bracket 44 and fasteners 46, 48. The roller carriage 36 may facilitate movement of the door 24 and the panels 28, 30. In particular, as the door 24 is moved between the open and closed positions, the connecting member 40 may pivot relative to the roller carriage 36 and the roller carriage may roll along the track 38. As discussed above, the door 24 may be connected to the shed 10 in a variety of suitable configurations and arrangements. Thus, for example, while a single roller carriage 36 may be shown in the accompanying figures, two or more roller carriages may used, if desired. Other types of structures may also be used to connect the doors 24, 26 and/or the panels 28, 30, 32 to the shed 10.

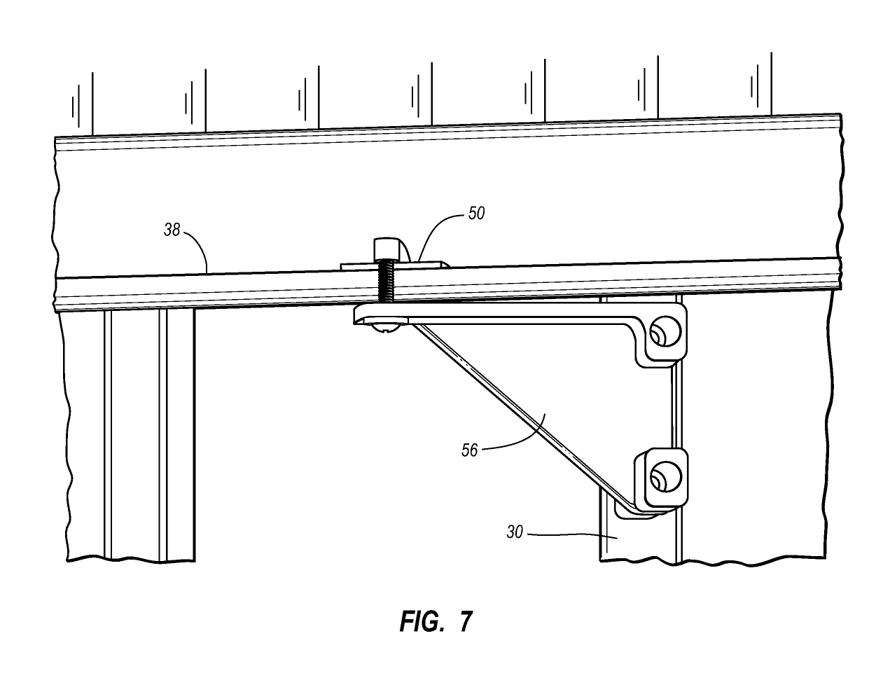

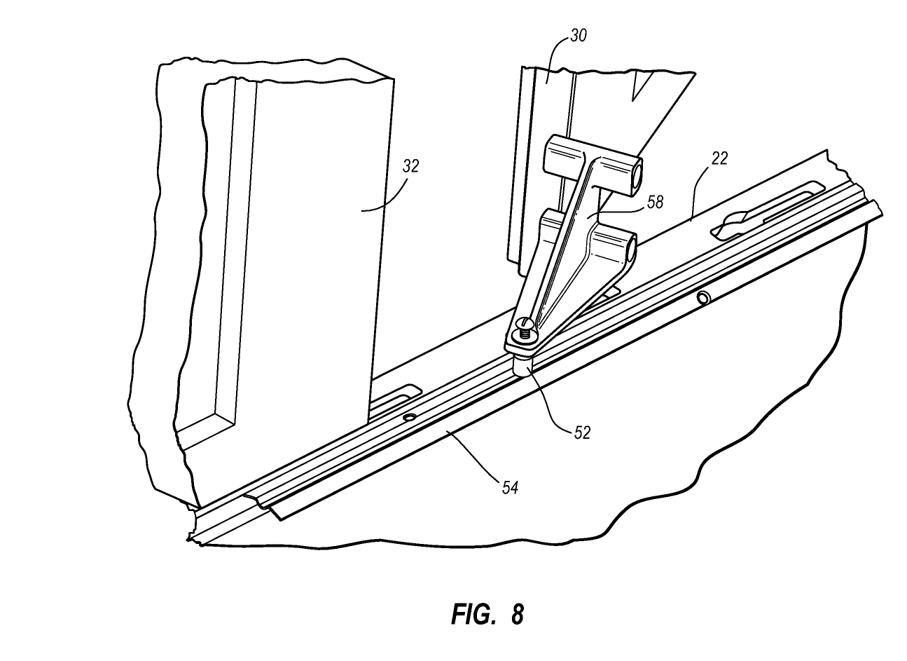

For example, in the exemplary embodiment shown in FIGS. 7-8, a slider carriage 50 may be coupled to the track 38 and the panel 30 of the door 24 may be connected to the carriage. In addition, the panel 30 may include or be connected to a positioning member 52 that is coupled to a track 54, which may be connected to or disposed in the floor 22. In greater detail, the panel 30 may be connected to the slider carriage 50 by a connecting member 56 and the panel may be connected to the positioning member 52 by a connecting member 58. The panel 30 may be connected to the connecting members 56, 58 using one or more brackets, fasteners and the like. As the door 24 is moved between the open and closed positions, the connecting members 56, 58 may respectively pivot relative to the slider carriage 50 and the positioning member 52, which may slide along the tracks 38, 54, respectively.

The shed 10 may also include a frame 55 and the doors 24, 26 may be connected to the frame. For example, the doors 24, 26 may be pivotally connected to the frame 55 by hinges and/or the doors may move along or relative to the frame by, for instance, sliding. The frame 55 is preferably sized and configured to add stability and/or rigidity to the shed, which may desirably help support the doors 24, 26 as they move between open and closed positions. In further detail, the frame 55 may include or be connected to the track 38. The frame 55 may also include corner posts 57 and braces 59 that may be connected to the track 38. Additionally, the braces 59 may be connected to the corner posts 57. Desirably, the corner posts 57 are relatively small, which may increase the size of the width w of the opening. The braces 59 preferably have a generally L-shaped configuration, but the braces may have other suitable shapes and configurations. The frame 55 and its components are preferably constructed from a strong and/or rigid material, such as metal. It will be appreciated, however, that the frame 55 and its components may be constructed from other materials having other suitable characteristics. It will also be appreciated that the frame 55 may include a variety of other suitable components and the frame may have a variety of suitable shapes, sizes, configurations and arrangements depending, for example, upon the size and configuration of the opening or shed 10.

The panels 28, 30, 32 of the doors 24, 26 are preferably constructed from blow-molded plastic and may include hollow interior portions and/or depressions, as discussed above. If desired, the shed 10 may include reinforcements that may be sized and configured to increase the strength and/or rigidity of various portions of the shed, such as the blow-molded plastic panels 28, 30, 32. For example, the shed 10 may include one or more reinforcing members 60 that have different capabilities or characteristics than the panels 28, 30, 32. For instance, the reinforcing members 60 may have different strength, resilience, compression and/or tension capabilities than the panels 28, 30, 32, which may allow the panels to be reinforced. Advantageously, the reinforced panels may have greater strength, rigidity, impact resistance, resilience and/or ability to prevent deformation.

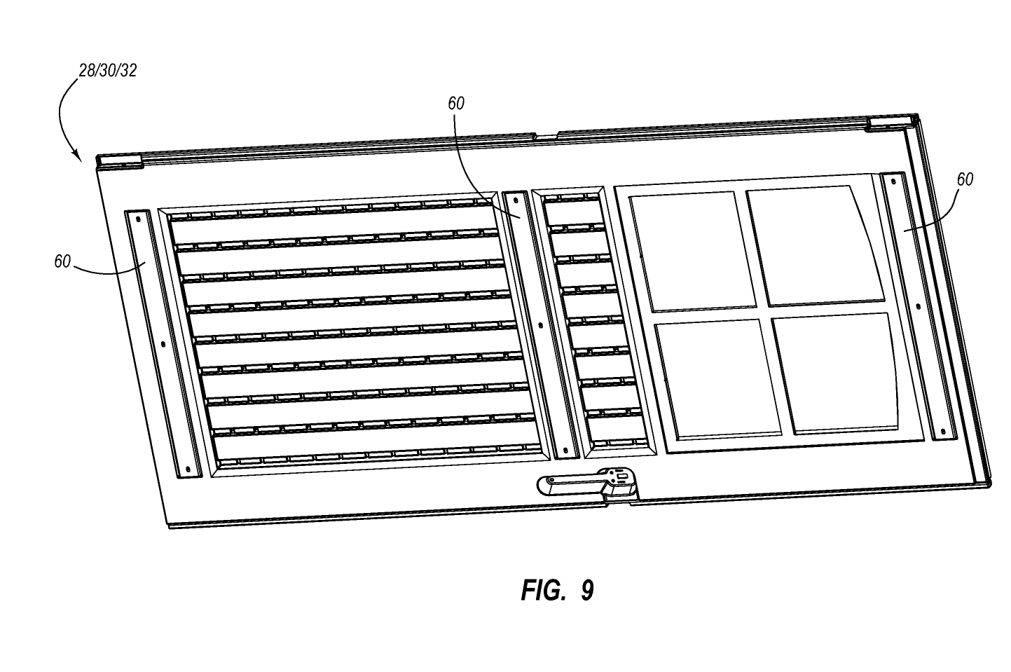

In greater detail, as seen in FIGS. 9-11, the door panels 28, 30, 32 may be constructed from blow-molded plastic and may include one or more reinforcing members 60. It will be appreciated that other portions of the shed 10, such as the walls, roof and floor, may also be reinforced by one or more reinforcing members 60. As shown in the accompanying figures, the reinforcing members 60 are preferably at least partially disposed within receiving portions 62 and the receiving portions may be integrally formed during the blow-molding process. The reinforcing members 60 preferably have different characteristics and properties than the blow-molded plastic components and structures. Additionally, the reinforcing members 60 may be sized and configured to increase the strength and/or rigidity of the blow-molded plastic components. While the reinforcing members 60 are preferably constructed from metal, other suitable materials may also be used.

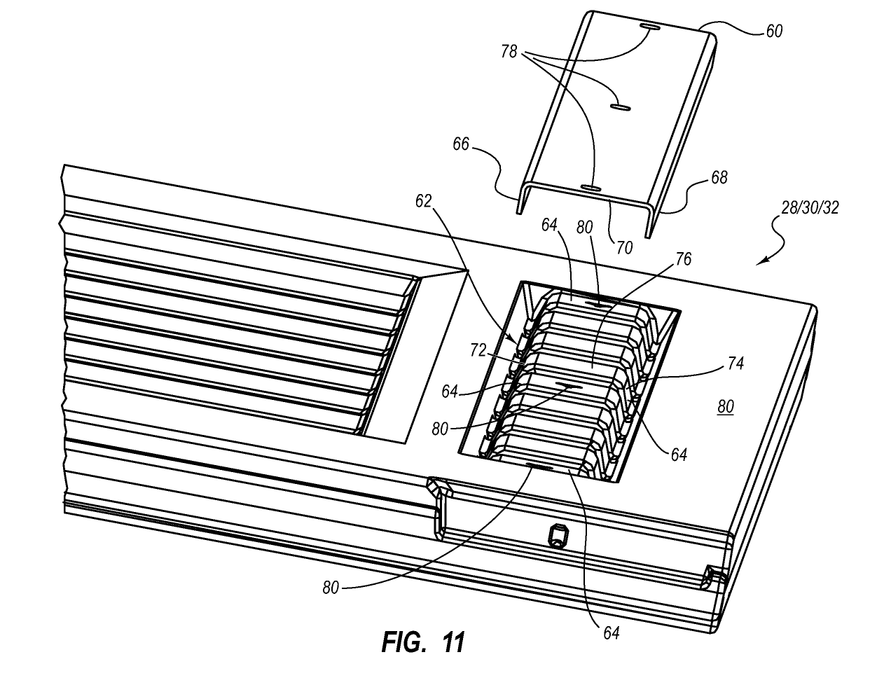

As shown in FIG. 11, the receiving portion 62 may include one or more projections 64. The projections 64 may be sized and configured to contact, abut and/or engage the reinforcing member 60 and the projections may help position the reinforcing member in a desired position. For instance, as shown in FIG. 11, the reinforcing member 60 may have an elongated body with a first flange 66, a second flange 68 and an intermediate portion 70 arranged in a generally U-shaped configuration. The projections 64 may include first, second and third portions 72, 74, 76, respectively, that may contact, abut and/or engage the first flange 66, the second flange 68 and the intermediate portion 70. The projections 64 are preferably integrally formed during the blow-molding process, but the projections do not have to be integrally formed.

The reinforcing members 60 may include openings 78 to facilitate connecting the reinforcing members to the receiving portions 62. In addition, the projections 64 may include fastener bosses 80 that are sized and configured to receive a portion of the fasteners, which may facilitate connection of the reinforcing member 60 to the projections. It will be appreciated, however, that the reinforcing members 60 may be connected to the receiving portions 62, the projections 64 and/or other portions of the shed 10 using other types of fasteners; a snap, friction and/or interference fit; adhesives and other suitable means.

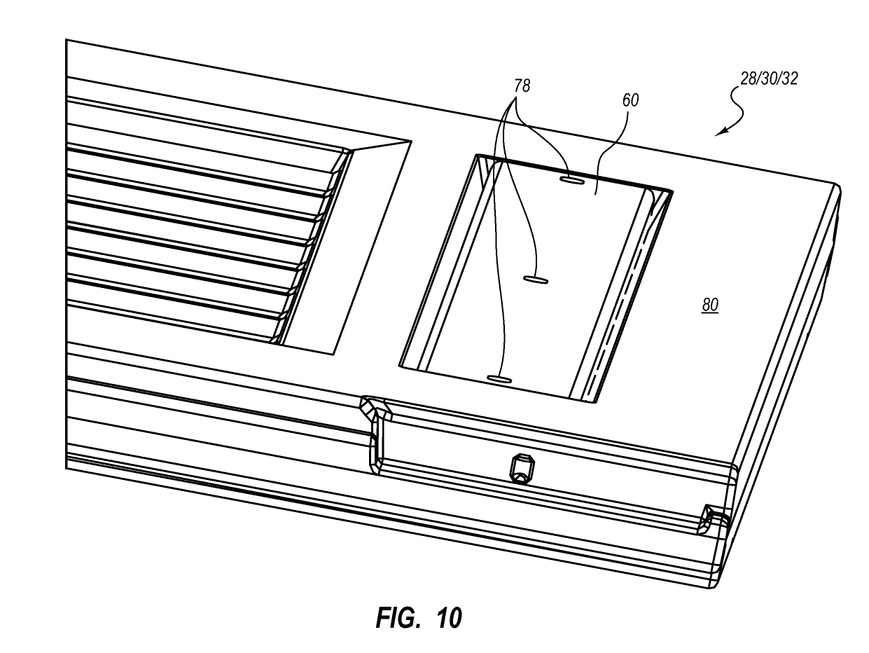

As shown in FIGS. 9-10, the intermediate portion 70 of the reinforcing member 60 may be generally aligned in the same plane with a generally flat exterior portion 80 of the blow-molded panel. The intermediate portion 70 of the reinforcing member 60, however, may be spaced apart from and/or generally parallel to the panel's exterior portion 80, if desired. For instance, the intermediate portion 70 of the reinforcing member 60 may be at least partially spaced inwardly from the panel's exterior portion 80. On the other hand, the intermediate portion 70 of the reinforcing member 60 may be at least partially spaced outwardly from the panel's exterior portion 80.

As shown in FIGS. 5 and 7, the reinforcing members 60 and the receiving portions 62 may have an elongated shape that may extend laterally in a direction from one edge towards a second edge. The reinforcing members 60 and/or the receiving portions 62 may extend at least thirty percent, forty percent, fifty percent, sixty percent, seventy percent or more of the distance between the edges, if desired. The reinforcing members 60 could also extend completely or substantially the distance between the edges, if desired.

As shown in FIG. 9, the doors 24, 26 and/or the panels 28, 30, 32 may include multiple reinforcing members 60. For example, a first reinforcing member may be disposed proximate an upper portion, a second reinforcing member may be disposed proximate a middle portion and a third reinforcing portion may be disposed proximate a lower portion of the doors 24, 26 and/or panels 28, 30, 32. The reinforcing members 60 could also be disposed along other portions of the shed 10 and the reinforcing members could be disposed at various angles, positions, orientations and directions. In addition, the reinforcing members 60 and/or receiving portions 62 could have other suitable shapes, sizes, configurations and arrangements depending, for example, the size and intended use of the shed 10.

In addition, the doors 24, 26 and the panels 28, 30 32 may include a front face, a rear face and a peripheral edge. The receiving portions 62 may be formed in at least one of the faces and may be spaced apart from the peripheral edge, if desired. The receiving portions 62 may also be disposed at other angles, positions, orientations and directions depending, for example, upon the size and configuration of the reinforcing members 60 and/or the intended use of the shed 10. It will be appreciated that doors 24, 26 and/or the panels 28, 30, 32 do not require any reinforcing members 60 and/or receiving portions 62.

As shown in FIGS. 1-4, the doors 24, 26 may have an attractive and aesthetically pleasing appearance. For example, the doors 24, 26 could match the other portions of the shed 10 or the doors may contrast with other portions of the shed. In addition, the doors 24, 26 may be used to create a carriage type door, but the doors could have any suitable look, design, style and/or arrangement.

Additionally, the doors 24, 26 could be secured in the opened and/or closed positions by, for example, locks, dead-bolts and/or latches. In addition, as mentioned above, the doors 24, 26 could have other suitable configurations and arrangements. For example, the doors 24, 26 may open vertically, horizontally or a combination of vertically and horizontally. The doors 24, 26 could also be removable and connected to the shed 10 in other suitable manners or configurations. Further, the doors 24, 26 could open inwardly and/or outwardly, as desired. Significantly, the doors 24, 26 may help protect the contents of the shed 10 and may help create a weather-tight enclosure. The doors 24, 26, however, could also include openings, vents, windows and the like, if desired.

The shed 10 may also include other suitable features and structures, such as disclosed in Assignee's U.S. Pat. No. 7,210,277, entitled PARTITION SYSTEM, or Assignee's co-pending U.S. patent application Ser. No. 11/091,848, entitled MODULAR ENCLOSURE, which was filed on Mar. 28, 2005; which are incorporated by reference in their entireties.

In addition, the shed 10 may have a variety of suitable shapes, sizes, configuration and features, such as disclosed in U.S. patent application Ser. No. 11/091,848, entitled MODULAR ENCLOSURE, which was filed on Mar. 28, 2005; U.S. Pat. No. 7,210,277, entitled PARTITION SYSTEM; U.S. design Pat. No. D506,267, entitled SHED; U.S. design Pat. No. D506,266, entitled SHED CONSTRUCTED FROM BLOW-MOLDED PLASTIC; U.S. design Pat. No. D505,497, entitled EXTERIOR SURFACE OF A SHED; U.S. design Pat. No. D506,011, entitled EXTERIOR PORTION OF A SHED; U.S. design Pat. No. D506,268, entitled EXTERIOR PORTION OF A SHED; which are incorporated by reference in their entireties.

Although this invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A shed comprising:
a first door foldable between an opened position and a closed position, the first door comprising:
a first panel constructed from blow-molded plastic, the first panel including a hollow interior portion formed during a blow-molding process; and
a second panel constructed from blow-molded plastic, the second panel including a hollow interior portion formed during a blow-molding process, the second panel movably connected to the first panel; and
a second door movable between an opened position and a closed position, the second door comprising a first panel constructed from blow-molded plastic, the first panel including a hollow interior portion formed during a blow-molding process, the first and second doors forming an opening that is at least about one hundred five inches wide when in the opened position, the first and second doors being spaced apart from each other when in the opened position, the first and second doors at least substantially closing the opening when in the closed position.

2. The shed as in claim 1, wherein the opening is at least about one hundred ten inches wide.

3. The shed as in claim 1, wherein the opening is at least about one hundred fifteen inches wide.

4. The shed as in claim 1, wherein the doors collectively extend along substantially all of a wall of the shed.

5. The shed as in claim 1, wherein the doors collectively extend along substantially all of a width of the shed.

6. The shed as in claim 1, wherein the opening extends along substantially all of a wall of the shed.

7. The shed as in claim 1, wherein the opening extends along substantially all of a width of the shed.

8. The shed as in claim 1, wherein the first panel of the first door further comprises an exterior surface and an elongated receiving portion integrally formed in the exterior surface during a blow-molding process, the receiving portion sized and configured to receive at least a portion of an elongated reinforcing member.

9. The shed as in claim 8, further comprising an elongated reinforcing member, at least a portion of the elongated reinforcing member being sized and configured to be disposed in the receiving portion.

10. An apparatus comprising:
an elongated metal reinforcing member; and
a blow-molded plastic panel including a first face, an opposing second face, a peripheral edge, a hollow interior portion formed during a blow-molding process and an elongated receiving portion integrally formed in the first face during the blow-molding process, the receiving portion being sized and configured to receive at least a portion of the reinforcing member, the receiving portion being spaced apart from the peripheral edge.

11. The apparatus as in claim 10, wherein the first face is a front face.

12. The apparatus as in claim 10, wherein the first face is a rear face.

13. The apparatus as in claim 10, wherein the reinforcing member includes a first flange, a second flange and an intermediate portion arranged in a generally U-shaped configuration.

14. The apparatus as in claim 13, further comprising one or more projections integrally formed in the receiving portion during a blow-molding process, at least one of the one or more projections being sized and configured to abut the first flange, the second flange and the intermediate portion of the reinforcing member.

15. The apparatus as in claim 10, further comprising one or more projections integrally formed in the receiving portion during a blow-molding process, the projections being sized and configured to abut at least a portion of the reinforcing member.

16. An apparatus comprising:
an elongated reinforcing member; and
a blow-molded plastic panel sized and configured to be connected to the elongated reinforcing member, the blow-molded plastic panel including an exterior surface, a hollow interior portion formed during a blow-molding process, an elongated receiving portion integrally formed in the exterior surface during the blow-molding process and one or more projections integrally formed in the receiving portion during the blow-molding process, at least one of the one or more projections being sized and configured to abut at least a portion of the reinforcing member.

17. The apparatus as in claim 16, wherein the reinforcing member includes a first flange, a second flange and an intermediate portion arranged in a generally U-shaped configuration.

18. The apparatus as in claim 17, wherein at least one of the one or more projections is sized and configured to abut the first flange, the second flange and the intermediate portion of the reinforcing member.

19. A shed constructed from a plurality of panels constructed from blow-molded plastic, the blow-molded plastic panels including a first surface, a second surface and a hollow interior portion formed during the manufacturing process, the shed comprising:
a floor constructed from one or more blow-molded plastic panels;
one or more walls connected to the floor, the walls being constructed from one or more blow-molded plastic panels;
a roof connected to the walls, the roof being constructed from one or more blow-molded plastic panels;
an entrance to the shed, the entrance including a first side and a second side;
a first door disposed at least proximate the first side of the entrance, the first door being constructed from one or more blow-molded plastic panels; and
a second door disposed at least proximate the second side of the entrance, the second door constructed from one or more blow-molded plastic panels;
wherein the first and second doors may be opened and closed to provide access to the shed.

20. The shed as in claim 19, wherein the first door is a bi-fold door and the second door is a regular door.

21. The shed as in claim 19, wherein the first door is constructed from two blow-molded plastic panels and the second door is constructed from a single blow-molded plastic panel.
